(19) United States
(12) Patent Application Publication
(10) Pub. No.: US 2016/0379448 A1
(43) Pub. Date: Dec. 29, 2016

(54) MANAGEMENT SYSTEM, MANAGEMENT DEVICE, AND NON-TRANSITORY RECORDING MEDIUM

(71) Applicant: Konami Digital Entertainment Co., Ltd., Tokyo (JP)

(72) Inventor: Masato Okuaki, Minato-ku (JP)

(21) Appl. No.: 15/263,197

(22) Filed: Sep. 12, 2016

Related U.S. Application Data
(63) Continuation-in-part of application No. PCT/JP2015/053652, filed on Feb. 10, 2015.

(30) Foreign Application Priority Data
Mar. 13, 2014 (JP) 2014-050669

(51) Int. Cl. G07F 17/32

(52) U.S. Cl. CPC G07F 17/3258; G07F 17/3241; G07F 17/329; G07F 17/3272; G07F 17/3225

(57) ABSTRACT

A management system comprises: at least one gaming machine; and a management device that is communicably connected to the gaming machine with each other, in which the management device accumulates a value according to a betting operation by a player on the gaming machine in association with identification information of the player or identification information of a group that the player belongs to, and conducts bonus processing for a bonus corresponding to the accumulated value by using the identification information of the player or identification information of a member of the group when a predetermined condition associated with the player is satisfied.

### CROSS-REFERENCE TO RELATED APPLICATION

This application is a continuation-in-part of International Application No. PCT/JP2015/053652, filed Feb. 10, 2015. Note that this application claims the benefit of priority from Japanese Patent Application No. 2014-050669, filed Mar. 13, 2014, and the entire content of the basic applications are incorporated herein.

### TECHNICAL FIELD

The present disclosure relates to a management system, a management device, and a non-transitory recording medium.

### BACKGROUND ART

A conventional jackpot system is known which includes at least one gaming machine and a jackpot controller. As a type of jackpot game, there is known a progressive jackpot game in which the jackpot value increases with the amount of bet placed by a player on a gaming machine.

### CITATION LIST

### Patent Literature

Patent Literature 1: Japanese Unexamined Patent Publication No. 2009-72589.

Patent Literature 2: Japanese Unexamined Patent Publication No. 2009-112737.

### SUMMARY OF INVENTION

### Technical Problem

In a common progressive jackpot game, a plurality of players share a jackpot value. If any one of the players wins the progressive jackpot, the player is given the whole or part of the amount of money corresponding to the jackpot value.

Such a progressive jackpot game played by a plurality of players tends to easily increase the jackpot value compared to that played by a single player and thus makes players expect a big payback.

However, when other players win the progressive jackpot and get a large amount of money, the player feels like his bet was paid back to those players. Accordingly, the winning of the progressive jackpot by other players dramatically decreases the player's interest in the game.

In this technical field, a management system has been required which can suppress a reduction in the player's interest in gaming machines.

### Solution to Problem

A management system according to one aspect of the present disclosure comprises: at least one gaming machine; and a management device that is communicably connected to each of the gaming machine with each other, in which the management device accumulates a value according to a betting operation by a player on the gaming machine in association with identification information of the player or identification information of a group that the player belongs to, and conducts bonus processing for a bonus corresponding to the accumulated value by using the identification information of the player or identification information of a member of the group when a predetermined condition associated with the player is satisfied.

A management device according to one aspect of the present disclosure comprises: a receiver that receives a betting operation by a player from at least one gaming machine; an accumulator that accumulates a value according to a betting operation by the player on the gaming machine in association with identification information of the player or identification information of a group that the player belongs to; and a bonus processor that conducts bonus processing for a bonus corresponding to the accumulated value by using identification information of the player or identification information of a member of the group when a predetermined condition related to the player is satisfied.

A non-transitory recording medium storing a computer program according to one aspect of the present disclosure makes a computer function as: a receiver receiving a betting operation by a player from at least one gaming machine; an accumulator accumulating a value according to a betting operation by the player on the gaming machine in association with identification information of the player or identification information of a group that the player belongs to; and a bonus processor conducting bonus processing for a bonus corresponding to the accumulated value by using identification information of the player or identification information of a member of the group when a predetermined condition related to the player is satisfied.

### BRIEF DESCRIPTION OF DRAWINGS

FIG. 1 is block diagram of a management system according to the first embodiment.

FIG. 2 is a block diagram illustrating functional components of a casino management server in FIG. 1.

FIG. 3 illustrates a configuration of a database stored in the casino management server in FIG. 1.

FIG. 4 illustrates a process flow according to the first embodiment.

FIG. 5 illustrates a process flow in a mode different from that in FIG. 4.

FIG. 6 is a block diagram of a management system according to the second embodiment.

FIG. 7 illustrates a process flow according to the second embodiment.

### DESCRIPTION OF EMBODIMENTS

Embodiments of the present disclosure will now be described with reference to the attached drawings. It should be noted that common components in the drawings are denoted by the same reference sign and their description will not be repeated.

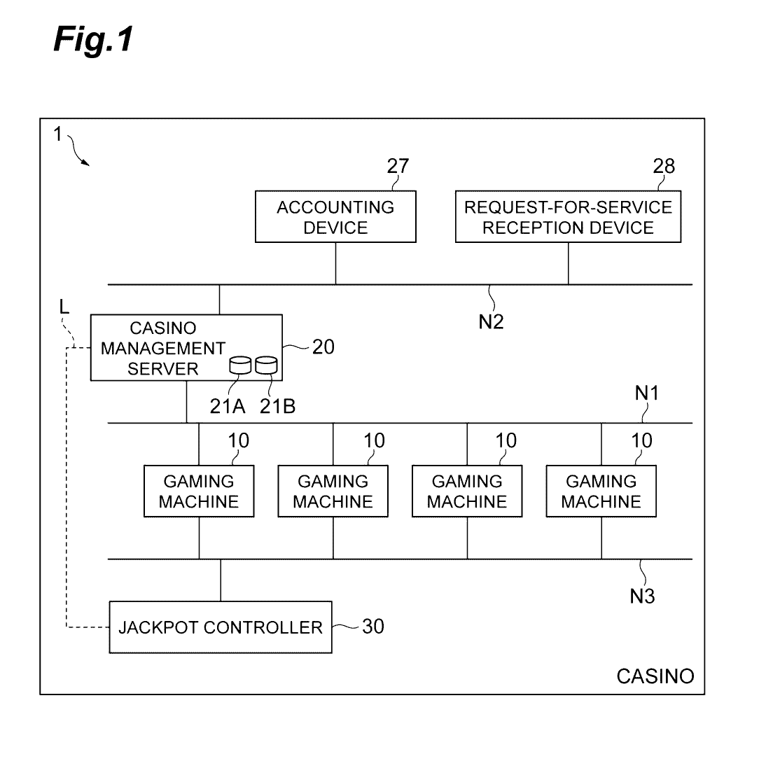

FIG. 1 is a block diagram of a management system 1 according to the first embodiment. The management system 1 is installed in a casino. In this description, a casino refers to a complex facility containing a casino floor installed with gaming machines, and additional facilities, such as restaurants, hotels, and theaters.

As shown in FIG. 1, the management system 1 includes a plurality of gaming machines 10, a casino management server 20, and a jackpot controller 30.

Each gaming machine 10, which is installed on the casino floor in the casino, is a video slot machine, for example. Each gaming machine 10 may be a slot machine, a poker machine, or a roulette machine including mechanical reels, or any other video gaming machine or mechanical gaming machine. Unique authentication data, namely machine ID is allocated to each gaming machine 10. It should be noted that, although FIG. 1 illustrates four gaming machines 10, the number of gaming machines 10 is changeable depending on the situation and therefore may be even one.

Each gaming machine 10 has a card reader not shown in the drawing. The card reader acquires information on a player from the ID card of the player. This ID card, which is also called “house card”, can be used as a membership card in the casino. Guests in the casino have such ID cards issued after the registration of personal information. For instance, a guest applies for ID issuance in advance and then registers his name, address, E-mail address and other personal information to get an ID card in return. The ID card has authentication data, namely customer ID unique to each person. The customer ID is stored, for example, in the IC chip, bar code, or magnetic tape on the ID card. It should be noted that personal information given at the acquisition of the ID card is stored, being associated with the customer ID, in the first database 21A in the casino management server 20 described later.

When a player lets the card reader of the gaming machine 10 read his ID card, the gaming machine 10 acquires the customer ID of the player and various information associated with the customer ID and stored in the first database 21A in the casino management server 20.

The casino management server 20 is device that acquires various data in the casino for central management of the information in the casino. The casino management server 20 is installed, for example, in a room for heavy security of the casino, i.e., a security room. The security room is restricted and the guests of the casino are therefore not allowed to enter this room. For instance, only the general manager of the casino is allowed to enter the security room.

The casino management server 20 is connected to each gaming machine 10 via an internal network N1 so as to communicate with each other. Specifically, each gaming machine 10 has a terminal box for communication with the casino management server 20. This terminal box allows for communication with the casino management server 20. It should be noted that the casino management server 20 communicates not only with the above-described gaming machines 10 but with any other gaming machine installed in the casino.

The casino management server 20 is connected not only to the gaming machines in the casino but to any other terminals in the casino so as to communicate with each other. For instance, as shown in FIG. 1, the casino management server 20 is connected to an accounting device 27 and a request-for-service reception device 28 via an internal network N2 so as to communicate with each other.

The accounting device 27 is, for example, an accounting terminal in a casher or a kiosk terminal on the casino floor, an accounting terminal at the reception counter of a hotel in the casino, or an accounting terminal in a restaurant in the casino. Similarly to each gaming machine 10, the accounting device 27 has a card reader through which it can read the customer ID from the guest's ID card.

The request-for-service reception device 28 is, for example, a system for booking a hotel in the casino or a reception system for booking theater tickets. Similarly to each gaming machine 10, the request-for-service reception device 28 has a card reader through which it can read the customer ID from the guest's ID card.

Accordingly, the casino management server 20 achieves central management of guest's information through customer IDs, thereby revealing all the contents and prices of services offered to the guests in the casino.

The jackpot controller 30 is installed on the casino floor or in the security room. The jackpot controller 30 is connected to each gaming machine 10, not via the internal network N1 but via an internal network N3.

The jackpot controller 30 provides the gaming machines 10 with a progressive jackpot. In particular, the jackpot controller 30 accumulates jackpot values according to a betting operation in each gaming machine 10. For example, the jackpot controller 30 receives the amount of bet placed for the game on each gaming machine 10 and adds the received amount of bet to the jackpot value at a constant ratio. Alternatively, the jackpot controller 30 may add a value dependent on that amount of bet to the jackpot value only if the amount of bet placed for one game reaches a predetermined amount.

The jackpot controller 30 determines the winner of the progressive jackpot for the plurality of gaming machines 10. Specifically, upon reception of information on the bet to one gaming machine 10, the jackpot controller 30 determines whether that gaming machine 10 wins the jackpot or not and sends the determination to the gaming machine 10. It should be noted that this determination of the winner may be performed only when a predetermined amount or more of bet is placed on any gaming machine 10.

The winner of the jackpot may be determined under a lottery system using a random number upon each reception of information on the bet placed on any gaming machine 10. Alternatively, a winning timing may be determined in advance (e.g., upon start of the accumulation of jackpot values) under a lottery system. The winning timing may be determined based on, for example, the jackpot value at which the jackpot is won, the date and time when the jackpot is won, the order in which the jackpot is won on the gaming machines after the start of the accumulation.

The jackpot controller 30 sends the jackpot value to the gaming machine 10 and always displays the latest jackpot value on the display of the gaming machine 10. The jackpot controller 30 also sends the jackpot value to the casino management server 20 and causes the casino management server 20 to always retain the latest jackpot value. The jackpot controller 30 sends the jackpot value in a predetermined cycle and timing (e.g., the timing of update of the jackpot value of the jackpot controller 30).

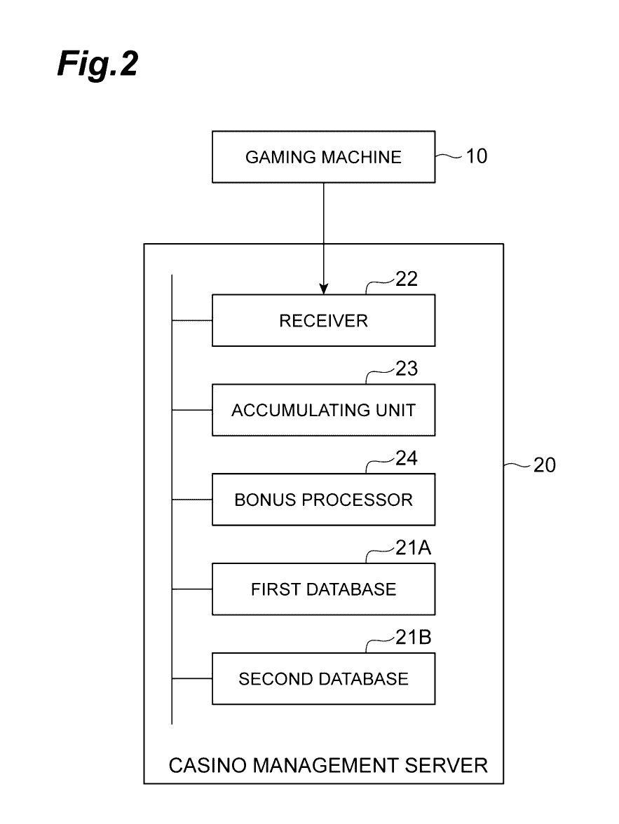

As illustrated in FIG. 2, the casino management server 20 includes a first database 21A, a second database 21B, a receiver 22, an accumulating unit 23, and a bonus processor 24 as functional components. The receiver 22 receives information on a betting operation by the player, from at least one gaming machine. The accumulating unit 23 accumulates values according to betting operations on the gaming machines 10 by the players in association with the players or the groups that the players belong to. The bonus processor 24 conducts bonus processing for a bonus corresponding to the accumulated value (described later), if a predetermined condition related to the player is satisfied.

The first database 21A and the second database 21B include a mass-storage device, such as a hard disc drive or a semiconductor memory.

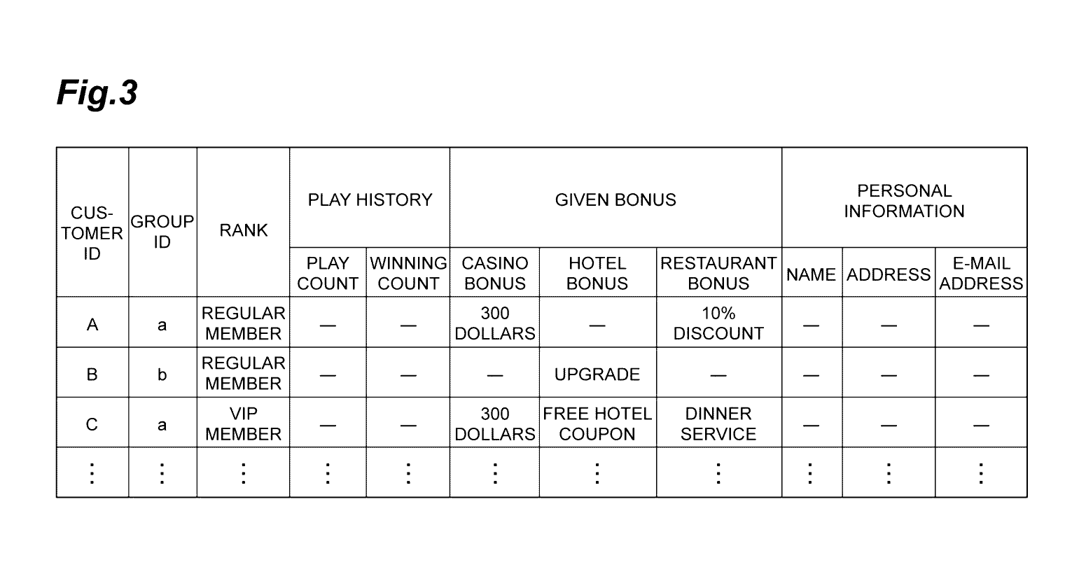

As shown in FIG. 3, the first database 21A contains attribute information, such as a group ID, a rank, a play history, given bonuses, and personal information, in association with the customer ID.

A group ID is identification information allocated to and unique to each group. A common group ID is given to guests associated to each other. Referring to FIG. 3, for example, guests identified by a customer ID “A” and a customer ID “C” are given a group ID “a”, which shows that these guests are associated with each other and belong to the same group. Examples of groups include family, company members, and a local circle. A group of family is given a group ID common to the family members after confirmation of personal information provided at the acquisition of the ID card. A group of company members or a local circle is given a group ID common to the members belonging to the group after the application, for example.

The rank is a type of grouping information for classifying the guests of the casino and is allocated based on the play history, for example. A “regular member” is a member registered to the casino and his total bet spent in the casino during a predetermined period (e.g., during the past month) is not more than a threshold. A “VIP member” is a member registered to the casino and his total bet spent in the casino during a predetermined period (e.g., during the past month) is above the threshold. The operator of the casino distinguishes “regular members” and “VIP members” and differentiates services offered to “regular members” and “VIP members” to give grant treatment to “VIP members”. The rank may also be determined, for example, by whether the member plays the game with a frequency at or above a predetermined level or whether the member has downloaded an application (described later) on his communication terminal.

The play history may contain the play count, i.e., the total number of times that the member played the game on the gaming machine 10 during a predetermined period. The play history may also contain the winning count, i.e., the total number of times that the member won the jackpot during a predetermined period. The play history may also contain the model name of the machine that the member played on, the payback percentage, and the total length of time spent on playing games, for example.

A given bonus contains information related to the right to get a bonus that the guest can receive. The content of the given bonus is updated by bonus processing (described later) conducted by the bonus processor 24. The given bonus will now be described taking the first database 21A in FIG. 3 as an example.

A customer ID “A” is associated with a bonus of 300 dollars which is a casino bonus that can be offered on the casino floor in the casino. Hence, the card reader of the accounting device 27 in a cash register reads the customer ID “A” in the ID card and refers to the first database 21A of the casino management server 20 to pay out 300 dollars for the player. It should be noted that the kiosk terminal can alternatively pay out 300 dollars upon an input from the customer ID “A”. The payout can be done in cash or equivalent tickets, for example.

The customer ID “A” is also associated with a 10% discount bonus which is a restaurant bonus that can be offered in a restaurant in the casino. Hence, the card reader of the accounting device 27 in the restaurant reads the customer ID “A” in the ID card and refers to the first database 21A of the casino management server 20 to accept a 10% discount.

A customer ID “B” is associated with a room upgrade bonus which is a hotel bonus that can be offered in a hotel in the casino. Hence, the card reader of the request-for-service reception device 28 in the hotel reads the customer ID “B” in the ID card and refers to the first database 21A of the casino management server 20 to upgrade the player's room.

Similarly to the player identified with the customer ID “A”, a customer ID “C” is associated with a bonus of 300 dollars which is a casino bonus that can be offered on the casino floor in the casino.

The customer ID “C” is further associated with a bonus of a free hotel coupon which is a hotel bonus that can be offered in a hotel in the casino. Hence, the card reader of the request-for-service reception device 28 in the hotel reads the customer ID “C” in the ID card and refers to the first database 21A of the casino management server 20 to issue the free hotel coupon.

The customer ID “C” is also associated with a bonus of the right to apply for a dinner service available only for guests having the bonus, which is a restaurant bonus that can be offered in a restaurant in the casino. Hence, the card reader of the request-for-service reception device 28 in the restaurant reads the customer ID “C” in the ID card and refers to the first database 21A of the casino management server 20 to receive the application for the dinner service.

As described above, the number of or level of bonuses associated with each customer ID is various and can be uniquely set by each casino.

The personal information includes information given at the acquisition of the ID card, e.g., the name, address, and E-mail address. The personal information may further include the age, occupation, family structure, and social security number.

The second database 21B contains uniquely accumulated values. Each uniquely accumulated value is associated with the corresponding customer ID or group ID. The accumulating unit 23 in the casino management server 20 accumulates uniquely accumulated values in the second database 21B, associating them with the respective customer IDs. In particular, while a player having a customer ID or group ID associated with a uniquely accumulated value is playing a game on the gaming machine 10, the accumulating unit 23 repeats accumulation of the uniquely accumulated value associated with the player, according to a betting operation by the player.

For instance, the casino management server 20 receives the amount of bet placed in each game from the gaming machine 10 at the receiver 22, and the accumulating unit 23 adds the received amount of bet to the uniquely accumulated value at a constant ratio. The casino management server 20 may add a value according to the amount of bet to the uniquely accumulated value only if the bet placed in one game is at or above a predetermined amount.

The jackpot controller 30 determines the winner of the progressive jackpot for the plurality of gaming machines 10. Specifically, upon reception of information on the bet placed on each gaming machine 10, the jackpot controller 30 determines whether that gaming machine 10 wins the jackpot or not and sends the determination to the gaming machine 10.

The winner of the jackpot may be determined under a lottery system using a random number upon each reception of information on the bet placed on any gaming machine 10. Alternatively, a winning timing may be determined in advance (e.g., upon start of the accumulation of jackpot values) under a lottery system. The winning timing may be determined based on, for example, the jackpot value at which the jackpot is won, the date and time when the jackpot is won, the order in which the jackpot is won on the gaming machines after the start of the accumulation.

The jackpot controller 30 sends the jackpot value to the gaming machine 10 and always displays the latest jackpot value on the display of the gaming machine 10. The jackpot controller 30 also sends the jackpot value to the casino management server 20 and causes the casino management server 20 to always retain the latest jackpot value. The jackpot controller 30 sends the jackpot value in a predetermined cycle and timing (e.g., the timing of update of the jackpot value of the jackpot controller 30).

As described above, the casino management server 20 can perform accumulating operations similar to those performed by the jackpot controller 30. It should be noted that the casino management server 20 should not necessarily follow the rules or styles applied to the jackpot controller 30. Hence, the casino management server 20 has no limit to accumulate values and thus exhibit high flexibility compared to the jackpot controller 30.

The casino management server 20 differs from the jackpot controller 30 in that it does not pay out any uniquely accumulated value accumulated in the second database 21B for an award of the game.

The casino management server 20 performs bonus processing instead of payout for an award of the game when a predetermined condition is satisfied. The bonus related to bonus processing to be performed is determined by the casino management server 20 according to the uniquely accumulated value. For instance, the casino management server 20 performs bonus processing of a higher-value bonus for a higher uniquely accumulated value.

The bonus processor 24 in the casino management server 20 updates, for example, the content of the given bonus in the attribute information in the first database 21A as bonus processing. Upon update of the given bonus, the guest having the customer ID related to that giving information is given the right to receive a bonus corresponding to the content of the updated given bonus. Those who can be given a bonus are players associated with uniquely accumulated values or members of groups associated with uniquely accumulated values. When one of the members of a group becomes a person to be given a bonus, all the members of the group may be given the bonus or only part (e.g., one) of the members of the group may be given the bonus. In addition, the members of the group may be given a bonus corresponding to the accumulated value when a predetermined percentage or number of members of the group satisfies a predetermined condition.

Examples of the predetermined condition for giving a bonus include that the player has won a particular prize, that the player has won the jackpot, that the player has played the game a predetermined number or more of times, and that the player has been determined as a winner by a lottery operation conducted by the casino management server 20 on the gaming machine 10.

A lottery operation by the casino management server 20 may be performed if a predetermined lottery-performing condition is satisfied. Examples of the lottery-performing condition include that the player has started to play a game on the gaming machine 10, that the player has performed a betting operation with a predetermined amount or more of bet on the gaming machine 10, that the player has achieved a predetermined game score on the gaming machine 10, that the accounting device 27 has performed an accounting operation involving a predetermined amount or more of money for the guest corresponding to the player on the gaming machine 10, and that the request-for-service reception device 28 has received a predetermined order for service from the guest corresponding to the player on the gaming machine 10. In addition, the winning rate for the lottery operation conducted by the casino management server 20 may be increased as the uniquely accumulated value increases. In the case where a plurality of different bonuses with different values is prepared, the winning rates for higher-value bonuses may be increased as the uniquely accumulated value increases, in the lottery operation conducted by the casino management server 20. In this case, the bonus processor 24 in the casino management server 20 conducts bonus processing for the bonus won in this lottery operation.

Imposing the condition that the above bonus is given when the player wins the jackpot or the lottery performed among the gaming machines 10 increases expectation for the jackpot or the lottery among the gaming machines 10, because the winner can be given the bonus in addition to a profit gained in the jackpot or the lottery performed among the gaming machines 10.

It should be noted that the predetermined condition for giving a bonus is not necessarily fixed but may be dynamically changed. The condition for giving the bonus may be changed, for example, according to the date and time, the play condition in the casino, and the uniquely accumulated value. Alternatively, the condition for giving the bonus itself may be determined by the lottery operation by the casino management server 20. The lottery results may be sent to the gaming machine 10 or a terminal owned by the player so that they can be noticed by the player.

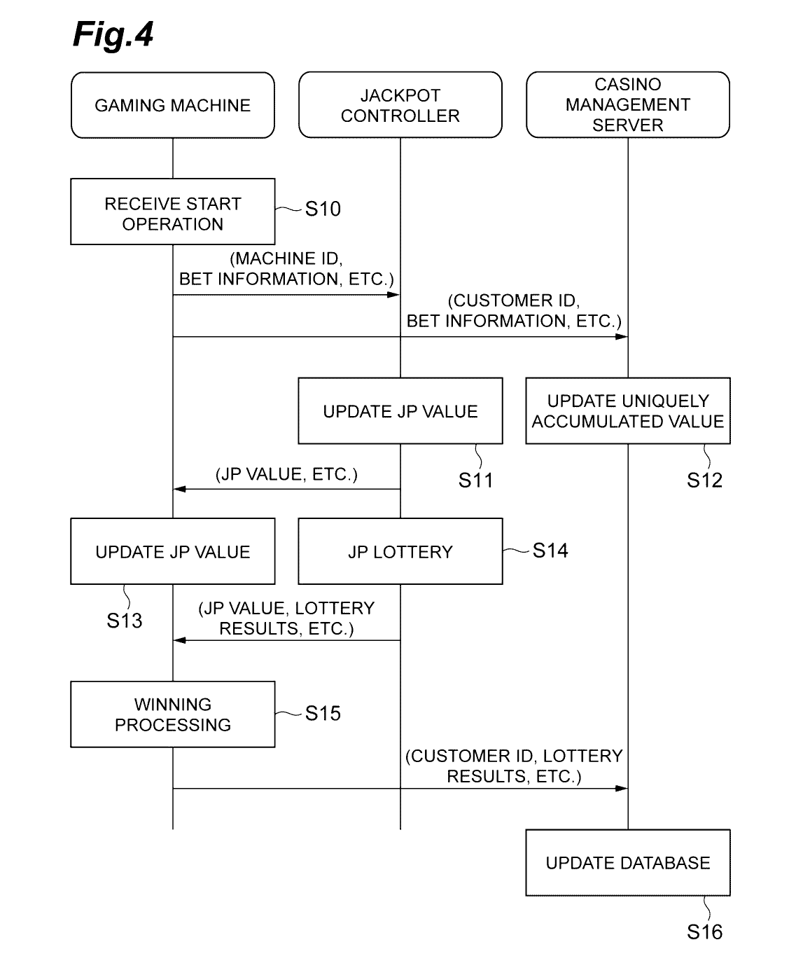

The process flow in the management system 1 will now be explained with reference to FIG. 4.

The player gives an operation to start the gaming machine 10. Specifically, as a start operation, the player lets the card reader of the gaming machine 10 read the information in the ID card of the player and places a bet on the gaming machine 10 to start the game. In response to the above-described start operation by the player, the gaming machine 10 sends bet information including the amount of bet in S10, which information is associated with the machine ID, to the jackpot controller 30 and also sends the bet information, which is associated with the customer ID read from the player's ID card, to the casino management server 20.

Upon reception of the machine ID and the bet information from the gaming machine 10, the jackpot controller 30 adds a value, which is equivalent to the amount of bet included in the bet information, to the jackpot value to update the jackpot value (JP value) as S11. After updating the jackpot value, the jackpot controller 30 sends the updated jackpot value to the gaming machine 10.

Upon reception of a customer ID and bet information from the gaming machine 10 at the receiver 22, the casino management server 20 acquires the uniquely accumulated value associated with the customer ID of the player from the second database 21B, and the accumulating unit 23 updates the acquired uniquely accumulated value by adding a value corresponding to the amount of bet, which is included in the bet information, to the acquired uniquely accumulated value, as S12.

Concurrently, upon reception of the updated jackpot value, the gaming machine 10 updates the jackpot value displayed on its monitor or any other display device, as S13.

After updating the jackpot value and sending it to the gaming machine 10, the jackpot controller 30 determines, under a lottery system, whether the gaming machine 10 from which the jackpot controller 30 received the machine ID wins the jackpot or not, as S14.

Afterwards, the jackpot controller 30 sends the lottery results to the gaming machine 10. If the jackpot is won here, the jackpot value at the time of the winning returns to the initial value and that jackpot value may be sent to the gaming machine 10 together with the lottery results.

If the gaming machine 10 wins the jackpot value, the gaming machine 10 conducts the predetermined winning processing as S15. The winning processing involves payout of the amount of money equivalent to the jackpot value.

After the winning processing (or before the winning processing), the gaming machine 10 sends the customer ID, which is associated with the lottery results and the jackpot value at the time of the winning, to the casino management server 20.

Upon reception of the customer ID and the associated lottery results from the gaming machine 10, the casino management server 20 updates the first database 21A as S16. At this time, at least the play history associated with the customer ID is updated.

In addition, when the above-described condition for giving a bonus (e.g., winning of the jackpot lottery performed by the jackpot controller 30, winning of a prize on the gaming machine 10, or winning of the lottery performed by the casino management server 20) is satisfied, the bonus processor 24 in the casino management server 20 modifies the contents in the first database 21A as bonus processing. Specifically, the bonus processor 24 in the casino management server 20 modifies the content of the given bonus associated with the customer ID of a person to give the bonus stored in the first database 21A so that the person to give the bonus can get the right to receive the predetermined bonus.

Accordingly, in the management system 1, the casino management server 20 accumulates values different from the jackpot, that is, uniquely accumulated values according to betting operations by the players on the gaming machines 10. The uniquely accumulated values are not associated with accumulation of the jackpot or the winning of the jackpot by other players or groups and can be only paid back to the respective players or player's groups in the forms of bonuses.

Hence, the casino management server 20 never pays back a uniquely accumulated value in the second database 21B, which value is allocated to one player belonging to one group, to other players who do not belong to the group. This makes the players keep expecting that they may be able to have their own uniquely accumulated values someday, which suppresses a reduction in the player's interest in the game.

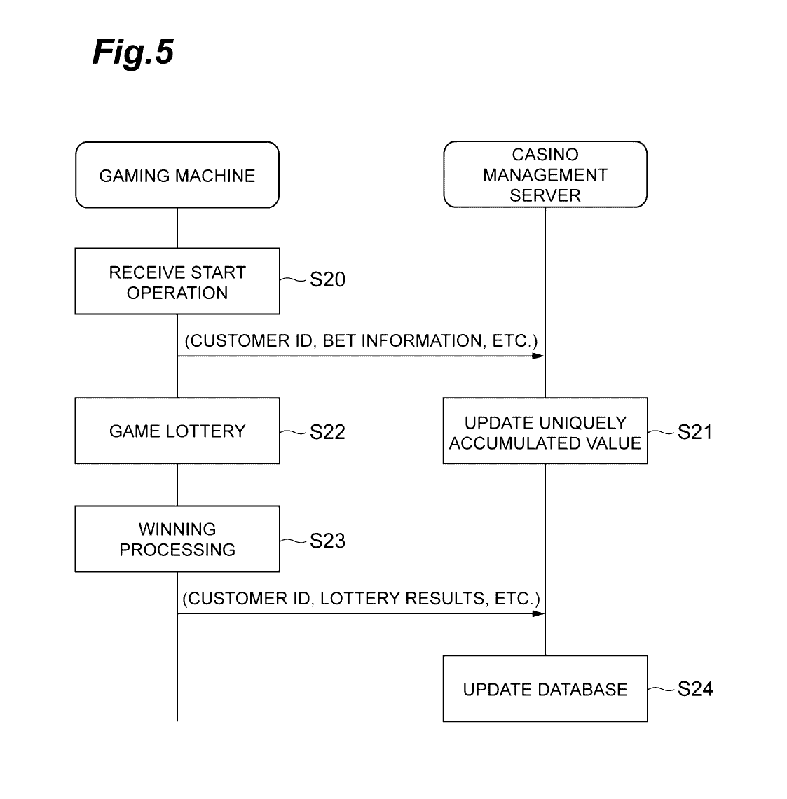

It should be noted that the above-mentioned effects can be provided even if the management system 1 according to the first embodiment does not include the jackpot controller 30. In this case, the process flow is as illustrated in FIG. 5.

Upon reception of the start operation by the player, the gaming machine 10 sends bet information including the amount of bet, which information is associated with the customer ID read from the player's ID card, to the casino management server 20 in S20, in a manner similar to S10 in FIG. 4 described above.

Upon reception of the customer ID and bet information from the gaming machine 10 at the receiver 22, the casino management server 20 acquires the uniquely accumulated value associated with the customer ID of the player stored in the second database 21B, and the accumulating unit 23 updates the uniquely accumulated value by adding the value corresponding to the amount of bet included in the bet information to the detected uniquely accumulated value, as S21.

Concurrently, upon reception of the start operation by the player, the gaming machine 10 determines whether the player wins a prize based on patterns of symbols of a video slot game, as S22.

If the player wins in the slot game, the gaming machine 10 conducts predetermined winning processing as S23. The winning processing involves payout dependent on the prize.

After the winning processing, the gaming machine 10 sends the lottery results of the slot game, which results are associated with the customer ID, to the casino management server 20.

Upon reception of the lottery results associated with the customer ID from the gaming machine 10, the casino management server 20 updates the first database 21A as S24. At this time, at least the play history associated with the customer ID is updated.

In addition, when the above-described predetermined condition for giving a bonus (e.g., winning of the jackpot lottery performed by the jackpot controller 30, winning of a prize on the gaming machine 10, or winning of the lottery performed by the casino management server 20) is satisfied, the bonus processor 24 in the casino management server 20 modifies the contents in the first database 21A as bonus processing. Specifically, the bonus processor 24 in the casino management server 20 modifies the content of the given bonus associated with the customer ID of a person to give the bonus stored in the first database 21A so that the person to give the bonus can get the right to receive the predetermined bonus.

Accordingly, even if the management system 1 does not include the jackpot controller 30, the casino management server 20 accumulates uniquely accumulated values according to betting operations by the players on the gaming machines 10, thereby suppressing a reduction in the interest of the players on the gaming machines 10 in the game.

It should be noted that the function of the casino management server 20 can also be achieved by executing a program with a computer.

In particular, a program can be constructed which instructs at least one computer to function in the same manner as the casino management server 20. The function achieved by executing such a program is similar to the above-mentioned casino management server 20, specifically, accumulates a value according to a betting operation by the player received from the gaming machine 10 by associating that value with the player's identification information (customer ID) or the identification information (group ID) of the player's group, and conducts bonus processing for a bonus corresponding to the accumulated value by using the player's identification information or the identification information of a member of the group when a predetermined condition related to the player is satisfied.

The program may be provided being stored in a non-transitory recording medium such as ROM, a semiconductor memory, or any other recording medium that can be read by a computer.

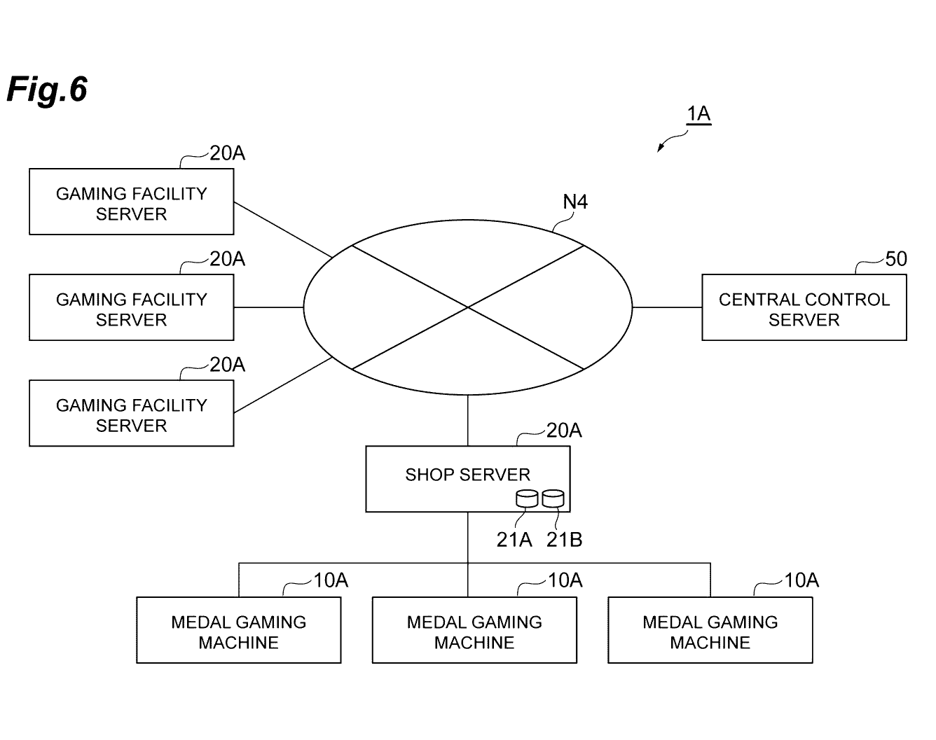

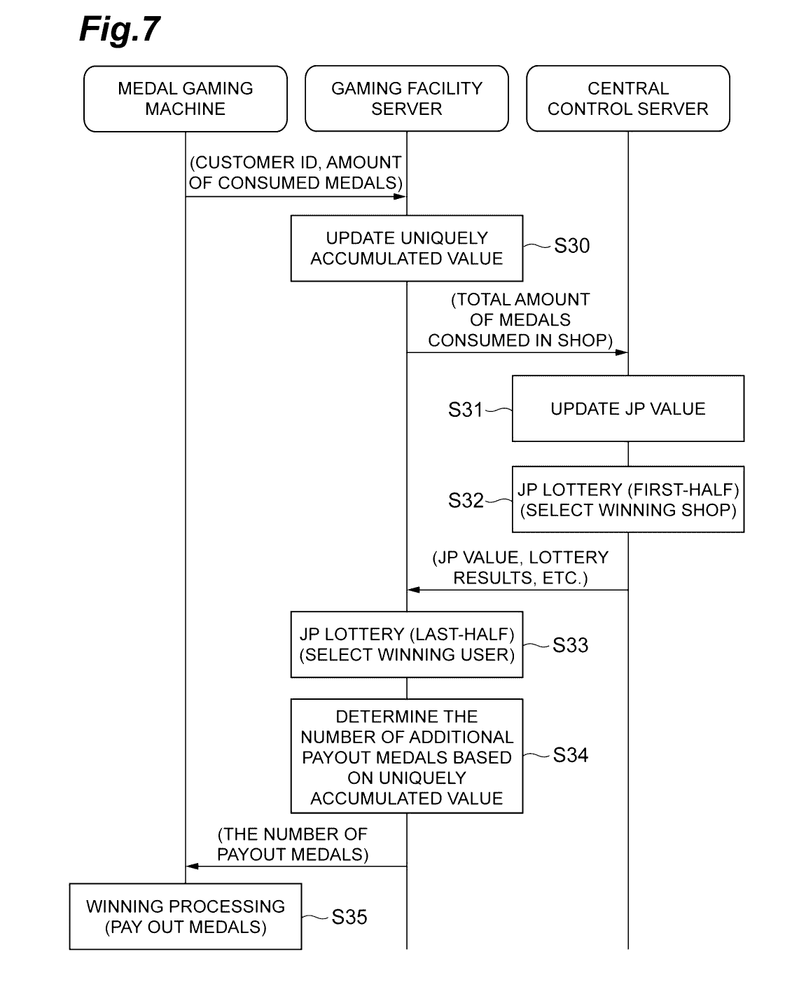

A management system 1A according to the second embodiment will now be described with reference to FIGS. 6 and 7.

As illustrated in FIG. 6, the management system 1A according to the second embodiment includes a plurality of medal gaming machines 10A, a gaming facility server 20A, and a central control server 50.

Each medal gaming machine 10A is a gaming machine on which medals having values available in the game are used. Examples include horse racing gaming machines and pusher gaming machines. FIG. 6 illustrates three medal gaming machines 10A although the number of medal gaming machines 10A can be changed as appropriate and may be even one. The plurality of medal gaming machines 10A may be of either the same type or different types.

Each medal gaming machine 10A has a card reader not shown in the drawing, as each gaming machine 10 according to the above-mentioned first embodiment. The medal gaming machine 10A is configured to receive user IDs and medal consumption information and send them to the gaming facility server 20A.

The gaming facility server 20A is connected to each medal gaming machine 10A via a game facility internal network so that they can communicate with each other. The gaming facility server 20A is device that acquires various data in the gaming facility for central management of the information in the gaming facility. The gaming facility server 20A includes databases 21A and 21B similar to the first database 21A and second database 21B in the casino management server 20 according to the above-mentioned first embodiment.

The gaming facility server 20A is also connected to an Internet N4 for communication with the central control server 50 via the Internet N4. The gaming facility server 20A calculates the total amount of consumed medals in the gaming facility by referring to the medal consumption information received from the medal gaming machines 10A in the gaming facility and sends information on the total amount of consumed medals to the central control server 50 in a predetermined timing (e.g., every predetermined period or every time a predetermined number of medals are consumed).

In the second embodiment, similarly to the first embodiment, the winner of the progressive jackpot is determined under a lottery system for the plurality of medal gaming machines 10A. In the second embodiment, the lottery to determine the winner of the progressive jackpot is performed by cooperation between the gaming facility server 20A and the central control server 50. The central control server 50 performs the first-half jackpot lottery for the winning gaming facilities, while the gaming facility server 20A performs the last-half jackpot lottery for the users.

It should be noted that a plurality of gaming facilities may win jackpots related to the central control server 50 and may be given different prizes. In particular, one gaming facility may be given a big prize and another gaming facility may be given a small prize.

The process flow in the management system 1A will now be described with reference to FIG. 7.

When the player consumes medals on the medal gaming machine 10A, the medal gaming machine 10A sends the customer ID read from the ID card of the player, which customer ID is associated with the amount of consumed medals, to the gaming facility server 20A. Upon reception of the customer ID and the amount of consumed medals from the medal gaming machine 10A, the gaming facility server 20A acquires the uniquely accumulated value associated with the customer ID of the player from the database 21B and updates the acquired uniquely accumulated value by adding a value corresponding to the amount of consumed medals to the acquired uniquely accumulated value, as S30. After updating the uniquely accumulated value, the gaming facility server 20A sends information, which is related to the total amount of consumed medals in the gaming facility under control of the gaming facility server 20A, to the central control server 50.

The central control server 50 accumulates and accumulatively adds part of the total amount of consumed medals received from each gaming facility server 20A included in the management system 1 to a jackpot value, as S31. Upon each reception of information related to the total amount of consumed medals from the gaming facility servers 20A, the central control server 50 performs the first-half jackpot lottery (group lottery) for the plurality of gaming facility servers 20A, as S32.

If the gaming facility that won the first-half jackpot lottery is selected by the central control server 50, the central control server 50 sends the lottery results and the jackpot value to the gaming facility server 20A in the winning gaming facility.

The winning gaming facility server 20A performs, as S33, the last-half jackpot lottery which is a jackpot lottery for the users. This determines the user who wins the jackpot. Subsequently, in S34, the database 21B in the gaming facility server 20A acquires a uniquely accumulated value associated with the winning user and determines the acquired uniquely accumulated value as the number of payout medals to be added to the jackpot value.

Afterwards, the gaming facility server 20A sends the number of payout medals to the medal gaming machine 10A that read the customer ID of the winning user, and the medal gaming machine 10A pays out medals as winning processing in S35.

As described above, the management system 1A according to the second embodiment involves bonus processing conducted by using the identification information of the player or a member of the group. In this bonus processing, the number of medals corresponding to the jackpot value and also the number of medals corresponding to the uniquely accumulated value is paid out. Thus, the medal gaming machine 10A, on which the player won a particular prize or the jackpot, can pay out the number of medals corresponding to the prize or jackpot value and, at the same time, additionally pay out the number of medals corresponding to the uniquely accumulated value.

Like in the management system 1 according to the first embodiment, in the management system 1A according to the above-mentioned second embodiment, the casino facility server 20A accumulates values different from the jackpot, that is, uniquely accumulated values according to betting operations by the players on the medal gaming machines 10A. The uniquely accumulated values are not associated with accumulation of the jackpot or the winning of the jackpot by other players or groups and can be only paid back to the respective players or player's groups in the forms of bonuses.

Hence, the game facility server 20A never pays back a uniquely accumulated value in the database 21B, which value is allocated to one player belonging to one group, to other players who do not belong to the group. This makes the players keep expecting that they may be able to have their own uniquely accumulated values someday, which suppresses a reduction in the player's interest in the game.

It should be noted that the function of the above-mentioned gaming facility server 20A can also be achieved by executing a program with a computer, like the function of the casino management server 20.

The present disclosure is not limited to the above embodiment and can be implemented in any other appropriate embodiment.

For example, the casino management server 20 should not necessarily be installed in the casino. It is sometimes preferable to manage a plurality of casinos run by the same operator with one casino management server 20. In this case, the casino management server 20 is installed in not in the other casinos but in only one casino. Alternatively, the casino management server 20 is not installed in any of these casinos.

For another example, the jackpot value in the jackpot controller 30 should not necessarily be sent to the casino management server 20 via the gaming machine 10, but may be directly sent to the casino management server 20 through a communication line (dashed line L in FIG. 1) provided as appropriate to connect the jackpot controller 30 to the casino management server 20.

A management system according to one aspect of the present disclosure comprises: at least one gaming machine: and a management device that is communicably connected to the gaming machine with each other, in which the management device accumulates a value (a uniquely accumulated value) according to a betting operation by a player on the gaming machine in association with identification information (a customer ID) of the player or identification information (a group ID) of a group that the player belongs to, and conducts bonus processing for a bonus corresponding to the accumulated value by using the identification information of the player or identification information of a member of the group when a predetermined condition associated with the player is satisfied. Examples of management system include, but are not limited to, the management system 1 in FIG. 1 or the management system 1A in FIG. 6. Examples of gaming machine include, but are not limited to, the gaming machine 10 in FIG. 1 or the medal gaming machine 10A in FIG. 6. Examples of management device include, but are not limited to, the casino management server 20 in FIG. 1 or the gaming facility server 20A in FIG. 6.

A management device according to one aspect of the present disclosure comprises: a receiver that receives a betting operation by a player from at least one gaming machine; an accumulator that accumulates a value according to a betting operation by the player on the gaming machine in association with identification information of the player or identification information of a group that the player belongs to; and a bonus processor that conducts bonus processing for a bonus corresponding to the accumulated value by using identification information of the player or identification information of a member of the group when a predetermined condition related to the player is satisfied. Examples of receiver include, but are not limited to, the receiver 22 in FIG. 2. Examples of accumulator include, but are not limited to, the accumulating unit 23 in FIG. 2. Examples of bonus processor include, but are not limited to, the bonus processor 24 in FIG. 2.

A computer program according to one aspect of the present disclosure makes a computer function as: a receiver receiving a betting operation by a player from at least one gaming machine; an accumulator accumulating a value according to a betting operation by the player on the gaming machine in association with identification information of the player or identification information of a group that the player belongs to; and a bonus processor conducting bonus processing for a bonus corresponding to the accumulated value by using identification information of the player or identification information of a member of the group when a predetermined condition related to the player is satisfied.

One embodiment further comprises a jackpot controller that accumulates a value of a progressive jackpot according to a betting operation of any player on the gaming machine and determines a winner of the progressive jackpot. Examples of jackpot controller include, but are not limited to, the jackpot controller 30 in FIG. 1.

In one embodiment, a bonus is values available in the game on gaming machines. For instance, a medal gaming machine can pay out a predetermined number of medals, which correspond to values available in the game, as a bonus. Examples of value in the game on the gaming machine include, but are not limited to, medals.

In one embodiment, the predetermined condition is that the gaming machine played by the player achieves a predetermined game score.

In one embodiment, the management device conducts a lottery operation when a lottery-performing condition is satisfied, and the predetermined condition is to win in the lottery operation performed by the management device.

One embodiment further comprises an accounting device which performs an accounting operation related to services provided to customers. Examples of accounting device include, but are not limited to, the accounting device 27 in FIG. 1.

One embodiment further comprises a request-for-service reception device that receives requests for services from customers. Examples of request-for-service reception device include, but are not limited to, the request-for-service reception device 28 in FIG. 1.

In one embodiment, a winning rate in the lottery operation conducted by the management device increases as the accumulated value increases.

In one embodiment, the bonus comprises a plurality of bonuses having different values, winning rates for higher-value bonuses increase as the accumulated value increases in the lottery operation conducted by the management device, and the management device conducts bonus processing corresponding to a bonus won in the lottery operation.

In one embodiment, when a predetermined number or more of members of the group satisfy the predetermined condition, the bonus processing is conducted by using identification information of all the members of the group. For example, control for players is performed with group IDs, so that all the members of the group can be given a bonus when a predetermined number of members of the group satisfy the predetermined condition.

In one embodiment, as the bonus processing, the management device stores information on a right to receive the bonus in association with the identification information of the player or the identification information of the member of the group.

One embodiment further comprises an accounting device which performs an accounting operation for services provided to the customers. This accounting device performs an accounting operation based on information on the right to receive the bonus, for a guest who is the player or member whose identification information is stored being associated with the information on the right to receive the bonus. Examples of accounting device include, but are not limited to, the accounting device 27 in FIG. 1.

One embodiment further comprises a request-for-service reception device that receives request for services from customers. The request-for-service reception device performs a receiving operation based on information on the right to receive the bonus, for a guest who is the player or member whose identification information is stored being associated with the information on the right to receive the bonus. Examples of request-for-service reception device include, but are not limited to, the request-for-service reception device 28 in FIG. 1.

What is claimed is:

1. A management system comprising:
at least one gaming machine; and
a management device that is communicably connected to the gaming machine with each other, wherein
the management device accumulates a value according to a betting operation by a player on the gaming machine in association with identification information of the player or identification information of a group that the player belongs to, and conducts bonus processing for a bonus corresponding to the accumulated value by using the identification information of the player or identification information of a member of the group when a predetermined condition associated with the player is satisfied.

2. The management system according to claim 1, further comprising a jackpot controller that accumulates a value of a progressive jackpot according to a betting operation of any player on the gaming machine and determines a winner of the progressive jackpot, wherein
the predetermined condition is that the gaming machine played by the player wins the progressive jackpot.

3. The management system according to claim 1, wherein the predetermined condition is that the gaming machine played by the player achieves a predetermined game score.

4. The management system according to claim 1, wherein
the management device conducts a lottery operation when a lottery-performing condition is satisfied, and
the predetermined condition is to win in the lottery operation performed by the management device.

5. The management system according to claim 4, further comprising an accounting device that performs an accounting operation related to services provided to customers, wherein
the lottery-performing condition is that the accounting device conducts a predetermined accounting operation related to the player.

6. The management system according to claim 4, further comprising a request-for-service reception device that receives requests for services from customers, wherein
the lottery-performing condition is that the request-for-service reception device performs an operation for receiving a request for a predetermined service related to the player.

7. The management system according to claim 4, wherein a winning rate in the lottery operation conducted by the management device increases as the accumulated value increases.

8. The management system according to claim 4, wherein
the bonus comprises a plurality of bonuses having different values,
winning rates for higher-value bonuses increase as the accumulated value increases in the lottery operation conducted by the management device, and
the management device conducts bonus processing corresponding to a bonus won in the lottery operation.

9. The management system according to claim 1, wherein when a predetermined number or more of members of the group satisfy the predetermined condition, the bonus processing is conducted by using identification information of all the members of the group.

10. The management system according to claim 1, wherein, as the bonus processing, the management device stores information on a right to receive the bonus in association with the identification information of the player or the identification information of the member of the group.

11. The management system according to claim 10, further comprising an accounting device that performs an accounting operation related to services provided to customers, wherein the accounting device performs an accounting operation based on information on the right to receive the bonus, for a customer who is the player or member whose identification information is stored being associated with the information on the right to receive the bonus.

12. The management system according to claim 10, further comprising a request-for-service reception device that receives requests for services from customers, wherein the request-for-service reception device performs a receiving operation based on information on the right to receive the bonus, for a customer who is the player or member whose identification information is stored being associated with the information on the right to receive the bonus.

13. A management device comprising:
a receiver that receives a betting operation by a player on at least one gaming machine;
an accumulator that accumulates a value according to a betting operation by the player on the gaming machine in association with identification information of the player or identification information of a group that the player belongs to; and
a bonus processor that conducts bonus processing for a bonus corresponding to the accumulated value by using identification information of the player or identification information of a member of the group when a predetermined condition related to the player is satisfied.

14. The management device according to claim 13, wherein, as the bonus processing, the bonus processor stores information on a right to receive the bonus in association with the identification information of the player or the identification information of the member of the group.

15. A non-transitory recording medium storing a computer program for making a computer function as:
a receiver receiving a betting operation by a player from at least one gaming machine;
an accumulator accumulating a value according to a betting operation by the player on the gaming machine in association with identification information of the player or identification information of a group that the player belongs to; and
a bonus processor conducting bonus processing for a bonus corresponding to the accumulated value by using identification information of the player or identification information of a member of the group when a predetermined condition related to the player is satisfied.

16. The non-transitory recording medium according to claim 15, wherein, as the bonus processing, the bonus processor stores information on a right to receive the bonus in association with the identification information of the player or the identification information of the member of the group.
